(19) United States
(12) Patent Application Publication
(10) Pub. No.: US 2013/0308349 A1
(43) Pub. Date: Nov. 21, 2013

(54) SWITCHING REGULATOR, THE CONTROL CIRCUIT AND THE METHOD THEREOF

(71) Applicant: Monolithic Power Systems, Inc., San Jose, CA (US)

(72) Inventors: Yangwei Yu, Hangzhou (CN); Yuancheng Ren, Hangzhou (CN); Junming Zhang, Hangzhou (CN); Sicong Lin, Hangzhou (CN); Jian Zhao, Hangzhou (CN)

(73) Assignee: MONOLITHIC POWER SYSTEMS, INC., San Jose, CA (US)

(21) Appl. No.: 13/895,299

(22) Filed: May 15, 2013

(30) Foreign Application Priority Data
May 15, 2012 (CN) 201210149295.X

(51) Int. Cl. H02M 3/335

(52) U.S. Cl. CPC H02M 3/33515
USPC 363/21.15

(57) ABSTRACT

A switching regulator that decreases power loss and resolves thermal issues by jumping its switching frequency to a maximum frequency when its load reaches a peak load.

### CROSS-REFERENCE TO RELATED APPLICATION(S)

This application claims priority to and the benefit of Chinese Patent Application No, 201210140205.X, filed May 15, 2012, which is incorporated herein by reference in its entirety.

### TECHNICAL HELD

The present invention relates to electronic circuits, more specifically, the present invention relates to switching regulators, the control circuit and the method thereof.

### BACKGROUND

Switching regulators are widely used in various applications. Prior switching regulators employ constant peak current mode control or constant switching frequency mode control, which lowers the efficiency when the load is light.

Some prior arts use multi-mode control during the operation of switching regulators, which decreases the switching frequency and the peak current when the load is light to increase the efficiency. FIG. 1 shows the waveforms of the switching frequency fₛ and the peak current I_{PEAK} varying with the feedback signal V_{FB} indicative of the load status, wherein the feedback V_{FB} becomes lower when the load becomes heavier. However, such multi-mode control scheme has a problem that when the power of the switching regulator reaches its peak power (i.e., the peak load), the switching frequency still increases. Thus the power loss is increased, which causes thermal issues.

### SUMMARY

It is an object of the present invention to provide an improved switching regulator, the control circuit, and the method thereof, which solves the above problems.

In accomplishing the above and other objects, there has been provided, in accordance with an embodiment of the present invention, a control circuit for a switching regulator, the switching regulator comprising at least a main switch controlled by a control circuit to operate between ON and OFF states to provide an output signal to power a load, the control circuit comprising: a load status detector having a first input terminal configured to receive a feedback signal indicative of the output signal, a second input terminal configured to receive a set threshold, and an output terminal configured to generate a load status detect signal based on the feedback signal and the set threshold; a first comparator having a first input terminal configured to receive a ramp signal, a second input terminal configured to receive a switching frequency reference, and an output terminal configured to generate a frequency control signal based on the ramp signal and the switching frequency reference, wherein the switching frequency reference is a normal load reference when the feedback signal is higher than the set threshold, and is a maximum load reference when the feedback signal is lower than the set threshold; and a logical unit coupled to the output terminal of the first comparator to receive the frequency control signal and to generate a gate control signal to control the main switch based on the frequency control signal.

In addition, there has been provided, in accordance with an embodiment of the present invention, a switching regulator, comprising: an input port configured to receive an input signal; an output port configured to provide an output signal to power a load; an energy storage component and a main switch coupled between the input port and the output port; a load status detector having a first input terminal configured to receive a feedback signal indicative of the output signal, a second input terminal configured to receive a set threshold, and an output terminal configured to generate a load status detect signal based on the feedback signal and the set threshold; a first comparator having a first input terminal configured to receive a ramp signal, a second input terminal configured to receive a switching frequency reference, and an output terminal configured to generate a frequency control signal based on the ramp signal and the switching frequency reference, wherein the switching frequency reference is a normal load reference when the feedback signal is higher than the set threshold, and is the maximum load reference when the feedback signal is lower than the set threshold; a current comparator having a first input terminal configured to receive a current reference signal, a second input terminal configured to receive a current sense signal indicative of a current flowing through the main switch, and an output terminal configured to generate a current control signal based on the current reference signal and the current sense signal; and a logical unit having a first input terminal coupled to the output terminal of the first comparator to receive the frequency control signal, a second input terminal coupled to the output terminal of the current comparator to receive the current control signal, and an output terminal configured to generate a gate control signal to control the main switch based on the frequency control signal and the current control signal.

Furthermore, there has been provided, in accordance with an embodiment of the present invention, a method used for a switching regulator, wherein the switching regulator comprises a main switch and an energy storage component, the method comprising: receiving an input signal; controlling the main switch to operate between ON and OFF states with a switching frequency, to control the energy storage component store and release energy to provide an output signal; deriving a feedback signal from the output signal, wherein the feedback signal is proportional to the output signal; and controlling the switching frequency to be a fixed value when the feedback signal is higher than a frequency setting signal; controlling the switching frequency to vary with the feedback signal when the feedback signal is lower than the frequency setting signal but is higher than a set threshold; and controlling the switching frequency to be a maximum frequency when the feedback signal is lower than the set threshold; wherein the frequency setting signal is higher than the set threshold.

### BRIEF DESCRIPTION OF THE DRAWINGS

FIG. 1 shows the waveforms of the switching frequency fₛ and the peak current I_{PEAK} varying with the feedback signal V_{FB} indicative of the load status in prior art switching regulators.

FIG. 2A schematically shows a switching regulator 100 in accordance with an embodiment of the present invention.

FIG. 2B schematically shows a switching regulator 200 in accordance with an embodiment of the present invention.

FIG. 3 schematically shows a ramp signal generator 50 in accordance with an embodiment of the present invention.

FIG. 4 shows an example diagram of the switching frequency f_{S} varies with the feedback signal V_{FB}.

FIG. 5 schematically shows a switching regulator 300 in accordance with an embodiment of the present invention.

FIG. 6 schematically shows a switching regulator 400 in accordance with an embodiment of the present invention.

FIG. 7 shows an example diagram of the switching frequency f_{S} and the peak current signal Iₚₑₐₖ varying with the feedback signal V_{FB} in the switching regulator 400.

FIG. 8 schematically shows a switching regulator 500 in accordance with an embodiment of the present invention.

FIG. 9 schematically shows a flowchart 600 of a method used for a switching regulator.

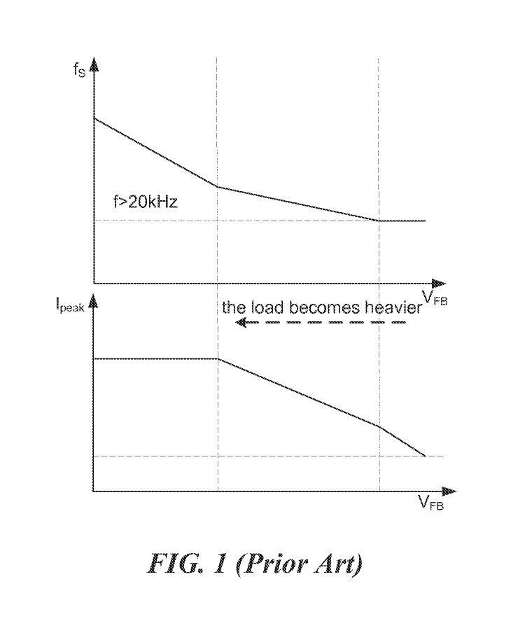

The use of the similar reference label in different drawings indicates the same of like components.

### DETAILED DESCRIPTION

Embodiments of circuits for a switching regulator, the control circuit and the method thereof are described in detail herein. In the following description, some specific details, such as example circuits for these circuit components, are included to provide a thorough understanding of embodiments of the invention. One skilled in the relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

It is to be understood in these letters patent that the meaning of “A” is coupled to “B” is that either A and B are connected to each other as described below, or that, although A and B may not be connected to each other as described below, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

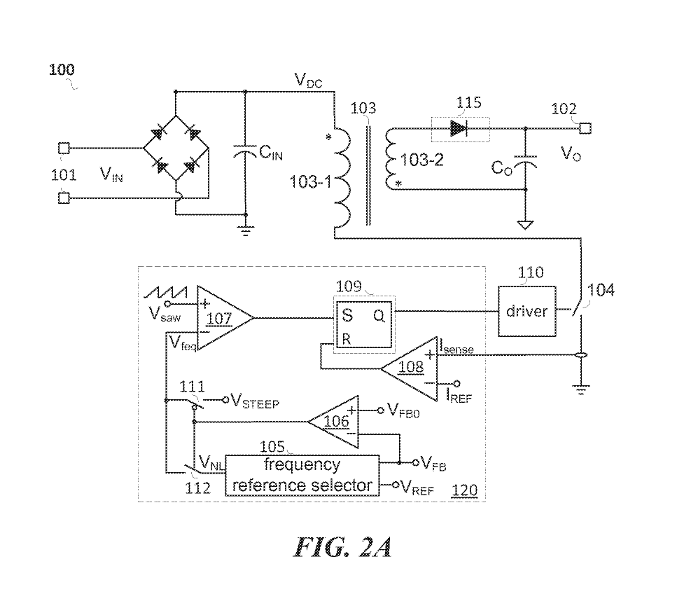

FIG. 2A schematically shows a switching regulator 100 in accordance with an embodiment of the present invention. In the example of FIG. 2A, the switching regulator 100 comprises: an input port 101 configured to receive an input signal V_{IN}; an output port 102 configured to provide an output signal V₀ to power a load; an energy storage component 103 and a main switch 104 coupled in series between the input port 101 and the output port 102; and a control circuit 120 configured to provide a gate control signal to control the main switch 104, wherein the control circuit 120 comprises: a frequency reference selector 105 having a first input terminal, a second input terminal, and an output terminal, wherein the first input terminal is configured to receive a feedback signal V_{FB} indicative of the output signal V_{O}, the second input terminal is configured to receive a frequency setting signal V_{REF}, and wherein based on selecting the lower value of between the feedback signal V_{FB} and the frequency setting signal V_{REF}, the frequency reference selector 105 generates a normal load reference V_{NL} at its output terminal; a load status detector 106 having a first input terminal, a second input terminal and an output terminal, wherein the first input terminal is configured to receive the feedback signal V_{FB}, the second input terminal is configured to receive a set threshold V_{FB0}, wherein the set threshold V_{FB0} is lower than the frequency setting signal V_{REF}, and wherein based on the feedback signal V_{FB} and the set threshold V_{FB0}, the load status detector 106 generates a load status detect signal; a first comparator 107 having a first input terminal, a second input terminal, and an output terminal, wherein the first input terminal is configured to receive a ramp signal Vsaw, the second input terminal is controllable coupled to the output terminal of the frequency reference selector 105 or to a maximum load reference V_{STEEP}, wherein when the feedback signal V_{FB} is higher than the set threshold V_{FB0}, the second input terminal of the first comparator 107 is coupled to the output terminal of the frequency reference selector 105 to receive the normal load reference V_{NL} as a switching frequency reference V_{feq}, and when the feedback signal V_{FB} is lower than the set threshold V_{FB0}, the second input terminal of the first comparator 107 is configure to receive the maximum load reference V_{STEEP} as the switching frequency reference V_{feq}, and wherein based on the ramp signal Vsaw and the switching frequency reference V_{feq}, the first comparator 107 generates a frequency control signal at its output terminal; a current comparator 108 having a first input terminal, a second input terminal, and an output terminal, wherein the first input terminal is configured to receive a current reference signal I_{REF}, the second input terminal is configured to receive a current sense signal Iₛₑₙₛₑ indicative of a current flowing through the main switch 104, and wherein based on the current reference signal I_{REF} and the current sense signal Iₛₑₙₛₑ, the current comparator 108 generates a current control signal at the output terminal; and a logical unit 109 having a first input terminal, a second input terminal, and an output terminal, wherein the first input terminal is coupled to the output terminal of the first comparator 107 to receive the frequency control signal, the second input terminal is coupled to the output terminal of the current comparator 108 to receive the current control signal, and wherein based on the frequency control signal and the current control signal, the logical unit 109 generates the gate control signal to control the main switch 104 to operate between ON and OFF states.

In one embodiment, the switching regulator 100 further comprises a driver 110 coupled to the logical unit 109 to receive the gate control signal. The driving capability of the gate control signal may get enhanced by the driver 110 before being delivered to the main switch 104.

In one embodiment, the switching regulator 100 further comprises: a first switch 111, coupled between the second input terminal of the first comparator 107 and the maximum load reference V_{STEEP}; and a second switch 112, coupled between the second input terminal of the first comparator 107 and the output terminal of the frequency reference selector 105; wherein the first switch 111 and the second switch 112 both have a control terminal coupled to the output terminal of the load status detector 106; and wherein the first switch 111 is turned off and the second switch 112 is turned on when the feedback signal V_{FB} is higher than the set threshold V_{FB0}; the first switch 111 is turned on and the second switch 112 is turned off when the feedback signal V_{FB} is lower than the set threshold V_{FB0}.

In one embodiment, the logical unit 109 comprises a RS flip-flop having a set terminal S, a reset terminal R and an output terminal Q, wherein the set terminal S acts as the first input terminal of the logical unit 109 to be coupled to the output terminal of the first comparator 107, the reset terminal R acts as the second input terminal of the logical unit 109 to be coupled to the output terminal of the current comparator 108, and the output terminal Q acts as the output terminal of the logical unit 109 to provide the gate control signal.

In one embodiment, the input signal V_{IN} is an alternating current (AC) signal, so the switching regulator 100 further comprises a rectifier bridge coupled between the input port 101 and the energy storage component 103, to rectify the input signal V_{IN} to a direct current (DC) signal.

In one embodiment, the energy storage component 103 comprises a transformer having a primary winding 103-1 and a secondary winding 103-2, wherein the primary winding 103-1 and the secondary winding 103-2 respectively comprises a first terminal and a second terminal, and wherein the first terminal of the primary winding 103-1 and the first terminal of the secondary winding 103-2 are configured as dotted terminals, the first terminal of the primary winding 103-1 is coupled to the rectifier to receive the DC signal V_{DC}, and the main switch 104 is coupled to the second terminal of the primary winding 103-1.

In one embodiment, the switching regulator 100 further comprises: an input capacitor C_{IN} coupled between the first terminal of the primary winding 103-1 and the primary reference ground; a secondary switch 115 coupled between the second terminal of the secondary winding 103-2 and the output port 102; and an output capacitor C_{O} coupled between the output port 102 and the first terminal of the secondary winding 103-2.

In one embodiment, the secondary switch 115 may comprise a diode.

In one embodiment, the feedback signal is generated by a feedback unit (not shown). The feedback unit may comprise a photocoupler. The photocoupler is configured to generate the feedback signal V_{FB} proportional to the output signal V_{O}, and to electrically isolate the primary side and the secondary side.

In one embodiment, the first switch 111 and the second switch 112 are replaced by a selectively switch 113, as shown in FIG. 2B. The second input terminal of the first comparator 107 is coupled to the maximum load reference V_{STEEP} or to the output terminal of the frequency reference selector 105 via the selectively switch 113, wherein the selective switch has a first selective terminal 1, a second selective terminal 2, a fixed terminal 3 and a control terminal 4, and wherein the first selective terminal 1 is coupled to the maximum load reference V_{STEEP}, the second selective terminal 2 is coupled to the output terminal of the frequency reference selector 105, the fixed terminal 3 is coupled to the second input terminal of the first comparator 107, the control terminal 4 is coupled to the output terminal of the load status detector 106; and wherein when the feedback signal V_{FB} is higher than the set threshold V_{FB0}, the selective switch 113 is controlled to couple the second selective terminal 2 to the fixed terminal 3, to let the second input terminal of the first comparator 107 be coupled to the output terminal of the frequency reference selector 105 to receive the receive the normal load reference V_{NL} as the switching frequency reference V_{feq}, when the feedback signal V_{FB} is lower than the set threshold V_{FB0}, the selective switch 113 is controlled to couple the first selective terminal 1 to the fixed terminal 3, to let the second input terminal of the first comparator 107 be configured to receive the maximum load reference V_{STEEP} as the switching frequency reference V_{feq}.

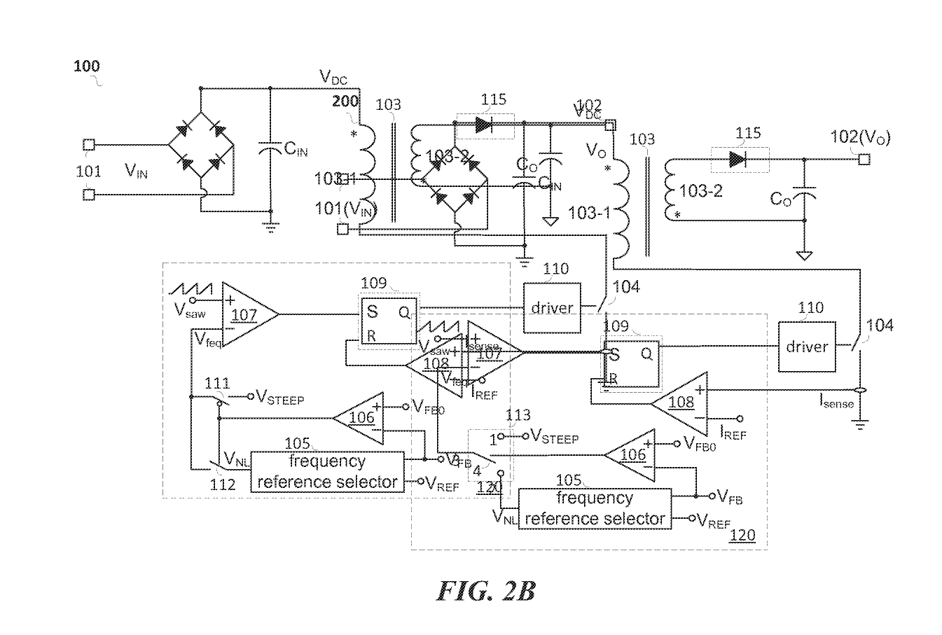

In one embodiment, the ramp signal Vsaw is generated by a ramp signal generator 50, as shown in FIG. 3. The ramp signal generator 50 comprises: a reset switch S₁, a charge capacitor Cₜ and a current source I_{Ct} coupled in parallel, wherein the reset switch S₁ comprises a control terminal configured to receive a short pulse signal G_{Pulse}, wherein the short pulse signal G_{Pulse} is indicative of the gate control signal, and is with a set pulse duration T_{P}, and further wherein a voltage drop across the charge capacitor Cₜ is the ramp signal Vsaw. The reset switch S₁ is turned on during the set pulse duration of the short pulse signal, to reset the voltage drop across the charge capacitor Cₜ, i.e., to reset the ramp signal Vsaw.

During the operation of the switching regulator 100, when the frequency control signal sets the gate control signal to be high, the main switch 104 is turned on. Then the input signal V_{IN}, the rectified bridge, the primary winding 103-1 and the main switch 104 form a current loop. The current of the primary side (i.e., the current flowing through the primary winding 103-1 and the main switch 104) starts to increase, and the energy storage component 103 starts to store energy. Accordingly, the current sense signal Iₛₑₙₛₑ also starts to increase. When the current sense signal Iₛₑₙₛₑ increases to the value of the current reference signal I_{REF}, the current control signal generated by the current comparator 108 turns to be high, which resets the gate control signal by the logical unit 109. Accordingly, the main switch 104 is turned off, and the stored energy is released through the secondary winding 103-2 and the secondary switch 115 to the output port 102. When the frequency control signal again sets the gate control signal to be high, the switching regulator 100 enters a new switching cycle and operated as discussed above. The switching cycle of the switching regulator 100 (i.e., the switching frequency) is determined by the ramp signal Vsaw and the first comparator 107. Specifically speaking, when the ramp signal Vsaw reaches the voltage level of the switching frequency reference V_{feq} at the second input terminal of the first comparator 107, the frequency control signal generated by the first comparator 107 turns to be high, which sets the gate control signal. At the ramp signal generator 50, the reset switch S1 is turned on during the set pulse duration T_{P}, which resets the voltage drop across the charge capacitor Cₜ. When the set pulse duration T_{P} is over, the charge capacitor Cₜ is charged by the current source I_{Ct}, so the voltage drop across the charge capacitor Cₜ starts to increase. When it increases to reach the voltage value V_{feq0} of the switching frequency reference V_{feq}, the gate control signal is set to be high. Then the short pulse signal G_{Pulse} has another high level pulse with the set pulse duration, which turns on the reset switch S₁ again to reset the voltage drop across the charge capacitor Cₜ, i.e. to reset the ramp signal Vsaw. The ramp signal generator 50 operates as discussed above to generate the ramp signal Vsaw, so as to control the switching frequency of the switching regulator 100. The capacitance C_{Ct} of the charge capacitor Cₜ, the current value I_{Ct0} of the current source I_{Ct}, the pulse duration T_{P} of the short pulse signal G_{Pulse} and the voltage value V_{feq0} of the switching frequency reference V_{feq} determine the switching frequency of the switching regulator 100, as shown below:

$${f}_{S} = \frac{1}{\frac{{C}_{ct} \times {V}_{feq 0}}{{I}_{Ct 0}} + {T}_{P}} \qquad ( 1 )$$

As shown in equation (1), for a given switching regulator 100, the capacitance C_{Ct} of the charge capacitor Cₜ, the current value I_{Ct0} of the current source I_{Ct}, and the pulse duration T_{P} of the short pulse signal G_{Pulse} are set, so the switching frequency of the switching regulator 100 is determined by the voltage value V_{feq0} of the switching frequency reference V_{feq}.

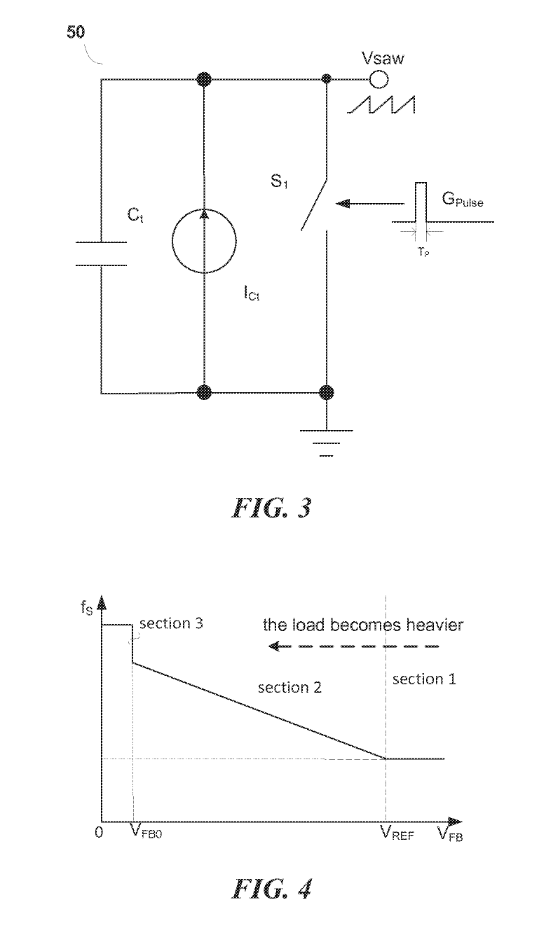

As will be discussed below in combination with FIG. 4, the switching frequency f_{S} of the switching regulator 100 varies with the load variation.

When the load is relatively light, the output voltage V_{O} is relatively high; and the feedback signal V_{FB} is also relatively high. If the feedback signal V_{FB} is higher than the frequency setting signal V_{REF}, the frequency reference selector 105 selects the frequency setting signal V_{REF} as the normal load reference V_{NL}. Because the set threshold V_{FB0} is lower than the frequency setting signal V_{REF}, the feedback signal V_{FB} is also higher than the set threshold V_{FB0}. As a result, the second input terminal of the first comparator 107 is coupled to the output terminal of the frequency reference selector 105 to receive the normal load reference V_{NL} as the switching frequency reference V_{feq}. Then equation (1) turns to be:

$${f}_{S} = \frac{1}{\frac{{C}_{ct} \times {V}_{REF}}{{I}_{Ct 0}} + {T}_{P}} \qquad ( 2 )$$

For a given switching regulator 100, the frequency setting signal V_{REF} is set, so the switching frequency of the switching regulator f_{S} is fixed, as section 1 shown in FIG. 4.

When the load becomes heavier, the output signal V_{O} and the feedback signal V_{FB} both decrease. When the feedback signal V_{FB} decrease to be lower than the frequency setting signal V_{REF} but higher than the set threshold V_{FB0}, the frequency reference selector 105 selects the feedback signal V_{FB} as the normal load reference V_{NL}. And the second input terminal of the first comparator 107 is still coupled to the output terminal of the frequency reference selector 105 to receive the normal load reference V_{NL} as the switching frequency reference V_{feq}. Then equation (1) turns to be:

$${f}_{S} = \frac{1}{\frac{{C}_{ct} \times {V}_{FB}}{{I}_{Ct 0}} + {T}_{P}} \qquad ( 3 )$$

So the switching frequency f_{S} of the switching regulator 100 increases as the load becomes heavier, as section 2 shown in FIG. 4.

When the load continually becomes heavier, so that the feedback signal V_{FB} decreases to be lower than the set threshold V_{FB0}, the load reaches a peak load. The second input terminal of the first comparator 107 is configured to receive the maximum load reference V_{STEEP} as the switching frequency reference V_{feq}. Then equation (1) turns to be:

$${f}_{S} = \frac{1}{\frac{{C}_{ct} \times {V}_{STEEP}}{{I}_{Ct 0}} + {T}_{P}} \qquad ( 4 )$$

So the switching frequency f_{S} of the switching regulator 100 is pulled to its maximum frequency, as section 3 shown in FIG. 4.

The operation of the switching regulator 200 in FIG. 2B is similar to that of the switching regulator 100 in FIG. 2A.

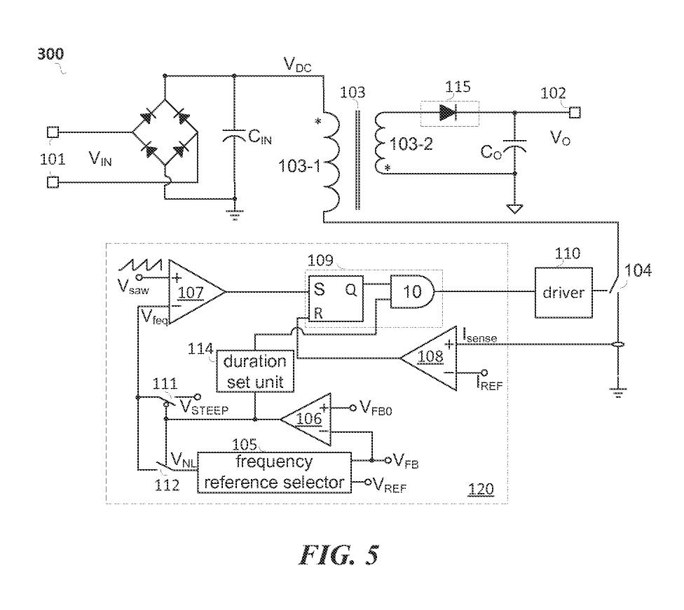

FIG. 5 schematically shows a switching regulator 300 in accordance with an embodiment of the present invention. The circuit configuration of the switching regulator 300 in FIG. 5 is similar to that of the switching regulator 100 in FIG. 2A, with a difference that the switching regulator 300 in FIG. 5 further comprises a duration set unit 114 having an input terminal and an output terminal, wherein the input terminal is coupled to the load status detector 106 to receive the load status detect signal, and wherein based on the load status detect signal, the duration set unit 114 generates a duration set signal at the output terminal.

In the example of FIG. 5, the logical unit 109 further has a third input terminal coupled to the output terminal of the duration set unit 114 to receive the duration set signal. The logical unit 109 comprises: a RS flip-flop having a set terminal 5, a reset terminal R and an output terminal Q, wherein the set terminal S acts as the first input terminal of the logical unit 109 to be coupled to the output terminal of the first comparator 107 to receive the frequency control signal, the reset terminal R acts as the second input terminal of the logical unit 109 to be coupled to the output terminal of the current comparator 108 to receive the current control signal, and wherein based on the frequency control signal and the current control signal, the RS flip-flop generates a trigger signal at the output terminal Q; and a logical AND circuit 10 having a first input terminal, a second input terminal and an output terminal, wherein the first input terminal acts as the third input terminal of the logical unit 109 to be coupled to the output terminal of the duration set unit 114 to receive the duration set signal, the second input terminal is coupled to the output terminal Q of the RS flip-flop to receive the trigger signal, and wherein based on the duration set signal and the trigger signal, the logical AND circuit 10 generates the gate control signal at the output terminal.

In one embodiment, when the feedback signal V_{FB} is lower than the set threshold V_{FB0}, the duration set signal is a logical high pulse signal with a set duration; and the gate control signal generated by the logical AND circuit 10 turns to be low when the set duration is over, to keep the main switch 104 at OFF status, so as to further solve the thermal issue. When the feedback signal V_{FB} is higher than the set threshold V_{FB0}, the duration set signal maintains high, to let the gate control signal generated by the logical unit 10 follow the trigger signal provided by the RS flip-flop.

The operation of the switching regulator 300 is similar to that of the switching regulator 100.

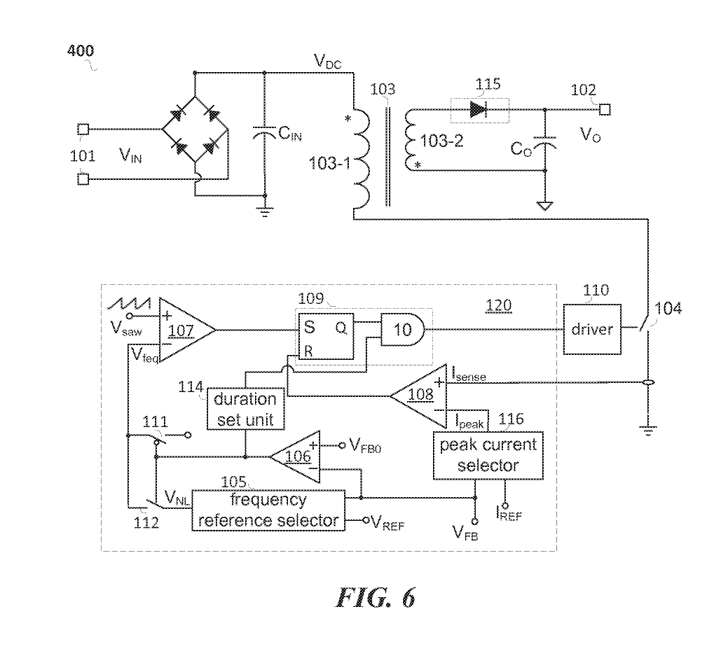

FIG. 6 schematically shows a switching regulator 400 in accordance with an embodiment of the present invention. The circuit configuration of the switching regulator 400 in FIG. 6 is similar to that of the switching regulator 300 in FIG. 5 with a difference that the switching regulator 400 in FIG. 6 further comprises a peak current selector 116 having a first input terminal, a second input terminal and an output terminal, wherein the first input terminal is configured to receive the feedback signal V_{FB}, the second input terminal is configured to receive the current reference signal I_{REF}, wherein based on the feedback signal V_{FB} and the current reference signal I_{REF}, the peak current selector 116 generates a peak current signal Iₚₑₐₖ at its output terminal by selecting the higher one between the feedback signal V_{FB} and the current reference signal I_{REF}.

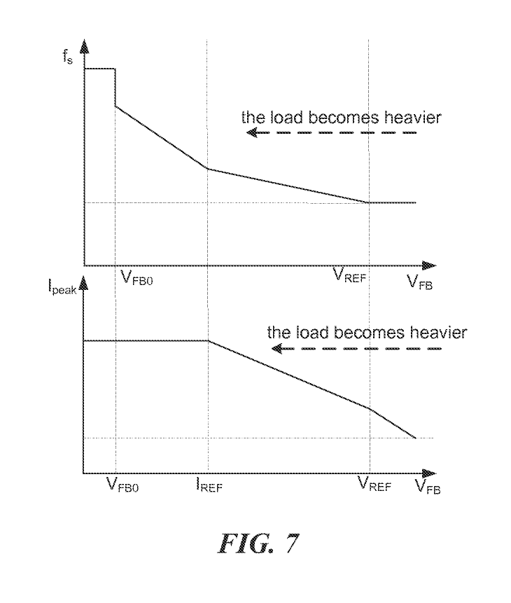

When the load is relative low, the output signal V_{O} and the feedback signal V_{FB} are relatively high. If the feedback signal V_{FB} is higher than the current reference signal I_{REF}, the peak current selector 116 selects the feedback signal V_{FB} as the peak current signal Iₚₑₐₖ. So the peak current signal Iₚₑₐₖ increases as the load becomes heavier, as shown in FIG. 7.

When the load becomes heavier, the output signal V_{O} and the feedback signal V_{FB} both decrease. When the feedback signal V_{FB} decrease to be lower than the current reference signal I_{REF}, the peak current selector 116 selects the current reference signal I_{REF} as the peak current signal Iₚₑₐₖ. So the peak current signal Iₚₑₐₖ does not vary with the load, as shown in FIG. 7.

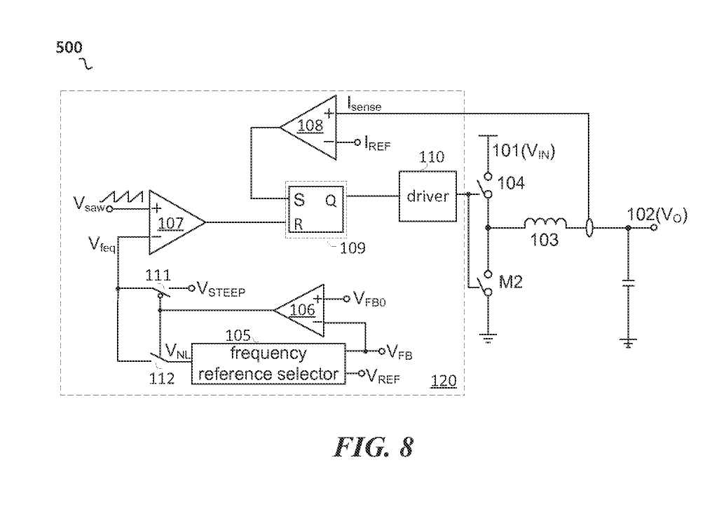

Several embodiments of the foregoing switching regulator are with isolated topology (a flyback converter topology as shown FIG. 2A, FIG. 2B, FIG. 5 and FIG. 6). But one skilled in the art should realize that the switching regulator may be with a non-isolated topology (e.g., a buck converter topology or a boost converter topology). FIG. 8 schematically shows a switching regulator 500 in accordance with an embodiment of the present invention.

The circuit configuration of the switching regulator 500 in FIG. 8 is similar to that of the switching regulator 100 in FIG. 2A. Different to the switching regulator 100 in FIG. 2A, the switching regulator 500 in FIG. 8 further comprises a low-side switch M2 coupled between the reference ground and the connection node of the energy storage component 103 and the main switch 104.

In the example of FIG. 8, the energy storage component comprises an inductor.

The operation of the switching regulator 500 in FIG. 8 is similar o that of the switching regulator 100 in FIG. 2A.

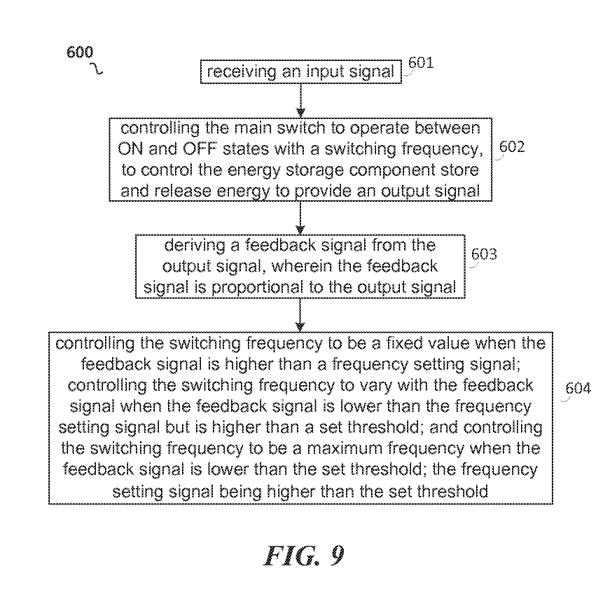

Furthermore, the present invention provides a method used for a switching regulator. FIG. 9 schematically shows a flowchart 600 of the method used for a switching regulator, wherein the switching regulator comprises a main switch and an energy storage component, the method comprises:

Step 601, receiving an input signal;

Step 602, controlling the main switch to operate between ON and OFF states with a switching frequency, to control the energy storage component store and release energy to provide an output signal;

Step 803, deriving a feedback signal from the output signal, wherein the feedback signal is proportional to the output signal; and

Step 804, controlling the switching frequency to be a fixed value when the feedback signal is higher than a frequency setting signal; controlling the switching frequency to vary with the feedback signal when the feedback signal is lower than the frequency setting signal but higher than a set threshold; and controlling the switching frequency to be a maximum frequency when the feedback signal is lower than the set threshold; wherein the frequency setting signal is higher than the set threshold.

In one embodiment, in step 602, controlling the main switch to operate between ON and OFF states with a switching frequency comprises: controlling the main switch to be OFF when a current flowing through the main switch to a peak current signal.

In one embodiment, the method further comprises: controlling a peak current flowing through the main switch to a fixed value when the feedback signal is lower than a current reference signal; and controlling the peak current flowing through the main switch to vary with the feedback signal when the feedback signal is higher than the current reference signal.

In one embodiment, the method further comprises: controlling the main switch to operate at the maximum frequency for a set duration when the switching frequency is the maximum frequency; and keep the main switch at OFF status when the set duration is over.

This written description uses examples to disclose the invention, including the best mode, and also to enable a person skilled in the art to make and use the invention. The patentable scope of the invention may include other examples that occur to those skilled in the art.

I/We claim:

1. A control circuit for a switching regulator, the switching regulator comprising at least a main switch controlled by a control circuit to operate between ON and OFF states to provide an output signal to power a load, the control circuit comprising:
a load status detector having a first input terminal configured to receive a feedback signal indicative of the output signal, a second input terminal configured to receive a set threshold, and an output terminal configured to generate a load status detect signal based on the feedback signal and the set threshold;
a first comparator having a first input terminal configured to receive a ramp signal, a second input terminal configured to receive a switching frequency reference, and an output terminal configured to generate a frequency control signal based on the ramp signal and the switching frequency reference, wherein the switching frequency reference is a normal load reference when the feedback signal is higher than the set threshold, and is a maximum load reference when the feedback signal is lower than the set threshold; and
a logical unit coupled to the output terminal of the first comparator to receive the frequency control signal and to generate a gate control signal to control the main switch based on the frequency control signal.

2. The control circuit of claim 1, further comprising:
a frequency reference selector having a first input terminal configured to receive the feedback signal, a second input terminal configured to receive a frequency setting signal, and an output terminal configured to generate the normal load reference based on selecting the lower value of between the feedback signal and the frequency setting signal; wherein the set threshold is lower than the frequency setting signal.

3. The control circuit of claim 1, wherein the ramp signal is generated by a ramp signal generator comprising a reset switch, a charge capacitor and a current source coupled in parallel, and wherein
the reset switch has a control terminal configured to receive a short pulse signal with a set pulse duration, wherein the short pulse signal is indicative of the gate control signal;
the reset switch is turned on during the set pulse duration of the short pulse signal; and
a voltage drop across the charge capacitor is the ramp signal.

4. The control circuit of claim 1, further comprising:
a duration set unit coupled to the output terminal of the load status detector to receive the load status detect signal and to generate a duration set signal; wherein
the logical unit is further coupled to the duration set unit to receive the duration set signal, and wherein the logical unit is configured to generate the gate control signal based on the frequency control signal and the duration set signal.

5. The control circuit of claim 1, further comprising:
a peak current selector having a first input terminal configured to receive the feedback signal, a second input terminal configured to receive a current reference signal, and an output terminal configured to generate a peak current signal based on selecting the higher value of between the feedback signal and the current reference signal; and
a current comparator having a first input terminal coupled to the output terminal of the peak current selector to receive the peak current signal, a second input terminal configured to receive a current sense signal indicative of a current flowing through the main switch, and an output terminal configured to generate a current control signal based on the peak current signal and the current sense signal; wherein
the logical unit is further coupled to the output terminal of the current comparator to receive the current control signal, and wherein the logical unit is configured to generate the gate control signal based on the frequency control signal and the current control signal.

6. A switching regulator, comprising:
an input port configured to receive an input signal;
an output port configured to provide an output signal to power a load;
an energy storage component and a main switch coupled between the input port and the output port;
a load status detector having a first input terminal configured to receive a feedback signal indicative of the output signal, a second input terminal configured to receive a set threshold, and an output terminal configured to generate a load status detect signal based on the feedback signal and the set threshold;
a first comparator having a first input terminal configured to receive a ramp signal, a second input terminal configured to receive a switching frequency reference, and an output terminal configured to generate a frequency control signal based on the ramp signal and the switching frequency reference, wherein the switching frequency reference is a normal load reference when the feedback signal is higher than the set threshold, and is the maximum load reference when the feedback signal is lower than the set threshold;
a current comparator having a first input terminal configured to receive a current reference signal, a second input terminal configured to receive a current sense signal indicative of a current flowing through the main switch, and an output terminal configured to generate a current control signal based on the current reference signal and the current sense signal; and
a logical unit having a first input terminal coupled to the output terminal of the first comparator to receive the frequency control signal, a second input terminal coupled to the output terminal of the current comparator to receive the current control signal, and an output terminal configured to generate a gate control signal to control the main switch based on the frequency control signal and the current control signal.

7. The control circuit of claim 6, further comprising:
a frequency reference selector having a first input terminal configured to receive the feedback signal, a second input terminal configured to receive a frequency setting signal, and an output terminal configured to generate the normal load reference based on selecting the lower value of between the feedback signal and the frequency setting signal; wherein the set threshold is lower than the frequency setting signal.

8. The control circuit of claim 6, wherein the ramp signal is generated by a ramp signal generator comprising a reset switch, a charge capacitor and a current source coupled in parallel, and wherein
the reset switch has a control terminal configured to receive a short pulse signal with a set pulse duration, wherein the short pulse signal is indicative of the gate control signal;
the reset switch is turned on during the set pulse duration of the short pulse signal; and
a voltage drop across the charge capacitor is the ramp signal.

9. The control circuit of claim 6, further comprising:
a duration set unit coupled to the output terminal of the load status detector to receive the load status detect signal and to generate a duration set signal; wherein the logical unit comprises:
a RS flip-flop having a set terminal coupled to the output terminal of the first comparator to receive the frequency control signal, a reset terminal coupled to the output terminal of the current comparator to receive the current control signal, and an output terminal configured to generate a trigger signal based on the frequency control signal and the current control signal; and
a logical AND circuit having a first input terminal coupled to the duration set unit to receive the duration set signal, a second input terminal coupled to the output terminal of the RS flip-flop to receive the trigger signal, and an output terminal configured to generate the gate control signal based on the duration set signal and the trigger signal.

10. The switching regulator of claim 6, further comprising: a first switch and a second switch, wherein
the second input terminal of the first comparator is configured to receive the maximum load reference via the first switch, and is configured to receive the normal load reference via the second switch; and
the first switch is turned off and the second switch is turned on when the feedback signal is higher than the set threshold; the first switch is turned on and the second switch is turned off when the feedback signal is lower than the set threshold.

11. The switching regulator of claim 6, further comprising a selective switch, wherein
the second input terminal of the first comparator is configured to receive the maximum load reference or to receive the normal load reference via the selectively switch.

12. A method used for a switching regulator, wherein the switching regulator comprises a main switch and an energy storage component, the method comprising:
receiving an input signal;
controlling the main switch to operate between ON and OFF states with a switching frequency, to control the energy storage component store and release energy to provide an output signal;
deriving a feedback signal from the output signal, wherein the feedback signal is proportional to the output signal; and
controlling the switching frequency to be a fixed value when the feedback signal is higher than a frequency setting signal; controlling the switching frequency to vary with the feedback signal when the feedback signal is lower than the frequency setting signal but is higher than a set threshold; and controlling the switching frequency to be a maximum frequency when the feedback signal is lower than the set threshold; wherein the frequency setting signal is higher than the set threshold.

13. The method of claim 12, wherein the step of controlling the main switch to operate between ON and OFF states with a switching frequency comprises: controlling the main switch to be OFF when a current flowing through the main switch reaches a peak current signal.

14. The method of claim 12, further comprising:
controlling a peak current flowing through the main switch to a fixed value when the feedback signal is lower than a current reference signal; and
controlling the peak current flowing through the main switch to vary with the feedback signal when the feedback signal is higher than the current reference signal.

15. The method of claim 12, further comprising:
controlling the main switch to operate at the maximum frequency for a set duration when the switching frequency is the maximum frequency; and
keeping the main switch at OFF status when the set duration is over.
